(19) United States
(12) Patent Application Publication
(10) Pub. No.: US 2025/0250827 A1
(43) Pub. Date: Aug. 7, 2025

(54) VEHICLE DOOR HANDLE ASSEMBLY

(71) Applicant: Minebea AccessSolutions France, Alfortville (FR)

(72) Inventors: Marvin GINIES, Alfortville (FR); Bruno VILOTTA, Alfortville (FR)

(73) Assignee: Minebea AccessSolutions France, Alfortville (FR)

(21) Appl. No.: 19/041,209

(22) Filed: Jan. 30, 2025

(30) Foreign Application Priority Data
Feb. 1, 2024 (EP) 24315038.0

(51) Int. Cl. E05B 85/10; E05B 17/18; E05B 79/06

(52) U.S. Cl. CPC E05B 85/103; E05B 17/18; E05B 79/06

(57) ABSTRACT

A vehicle door handle assembly includes a bracket to be fixed on an inner side of a door panel, a movable handle fastened to the bracket for moving between a retracted position in which the movable handle flushes with an outer side of the door panel and a deployed position, a security plate including a central opening and above to be fixed to the bracket, a lock to be positioned within the central opening of the security plate, and a plastic cover fastened to the bracket and/or to the security plate. The plastic cover covers the security plate. The plastic cover includes a central opening for receiving the lock.

### TECHNICAL FIELD

The present invention relates to the field of vehicle door handles to control the opening of vehicle doors and in particular to retractable vehicle door handles configured for moving from a retracted position wherein the handle flushes with the outer side of the door panel to reduce drag when the vehicle is moving and a deployed position wherein the handle can be grabbed by a user to open the door.

### BACKGROUND OF THE INVENTION

The vehicle door handles are usually electrical handles comprising an electric motor to move the handle from the retracted position to the deployed position and the handles are usually equipped with wireless control means to authorize the unlocking of the door and the deployment of the handle. However, it is also required to provide a manual access to the vehicle in case of emergency, for example in case of a dead battery of in case of a misfunctioning or breakdown of the wireless control means. A lock is therefore usually positioned next to the handle so that a user may unlock the vehicle using a key which is inserted in the lock. However, such a lock needs on one side to be protected from possible burglars and on the other side the lock and its protection mechanism need to be as hidden as possible to improve the aesthetic appearance of the vehicle door handle.

### SUMMARY OF THE INVENTION

It is therefore a goal of the present invention to provide a solution to overcome the above-mentioned problems in order to protect the lock without degrading the aesthetic appearance of the vehicle door handle.

Thus, the present invention refers to a vehicle door handle assembly comprising:
a bracket configured to be fixed on an inner side of a door panel,
a movable handle fastened to the bracket and configured for moving between a retracted position wherein the movable handle flushes with an outer side of the door panel and a deployed position,
a security plate comprising a central opening and configured to be fixed to the bracket,
a lock configured to be positioned within the central opening of the security plate, wherein the vehicle door handle assembly also comprises a plastic cover fastened to the bracket and/or to the security plate and configured for covering the security plate, the plastic cover comprising a central opening configured for receiving the lock.

The use if a plastic cover enables hiding the security plate so that the exact position and shape of the security plate remains unknown and so that the aspect of the handle is smooth and homogeneous with the rest of the handle even in the deployed position.

According to another aspect of the present invention, the plastic cover is clipped to the bracket and/or to the security plate.

According to another aspect of the present invention, the plastic cover comprises a first and a second pins arranged on a first side of the plastic cover and configured to be positioned in a respective first and second slots of the bracket or the security plate and a hook arranged on a second side of the plastic cover, opposite to the first side, and configured to be introduced within an opening of the bracket or the security plate for clipping the plastic cover to the bracket and/or to the security plate.

According to another aspect of the present invention, the vehicle door handle assembly also comprises a fork configured to be slid laterally by a screw to restrain the lock and/or the security plate in position in the bracket.

According to another aspect of the present invention, the security plate is made of steel. According to another aspect of the present invention, the movable handle comprises a manual release position wherein the lock can be positioned from the outside of the vehicle door panel in a recess of the bracket.

The present invention also refers to a method for assembling a vehicle door handle assembly as described previously on a door panel, the door panel comprising an opening, the method comprises the following steps:
positioning the security plate on the bracket,
fastening the plastic cover to the bracket and/or to the security plate,
positioning the bracket on an inner side of the door panel, the movable handle protruding through the opening of the door panel,
fixing the bracket on the inner side of the door panel, for example with screws,
setting the movable handle in the manual release position,
introducing the lock within a recess of the bracket through the central opening of the security plate and through the central opening of the plastic cover,
sliding a fork with a lateral screw to restrain the lock in position in the bracket.

According to another aspect of the present invention, the plastic cover is clipped to the bracket and/or to the security plate.

### BRIEF DESCRIPTION OF THE DRAWINGS

FIG. 1 is a perspective view of a portion of a door panel and a door handle in a retracted position;

FIG. 2 is a perspective view of the door handle of FIG. 1 in an opened position;

FIG. 3 is a perspective view of the door handle of FIG. 1 in an opened position with a key;

FIG. 4 is a perspective view of a security plate;

FIG. 5a is a perspective view of a portion of a bracket and a security plate;

FIG. 5b is a perspective and view of a portion of a bracket and a security plate fastened to the bracket;

FIG. 6a is a perspective view of a plastic cover according to an embodiment of the present invention;

FIG. 6b is another perspective view of a plastic cover according to an embodiment of the present invention;

FIG. 7 is a perspective view of a plastic cover positioned on a bracket;

FIG. 8 is a perspective view of a plastic cover fastened to the bracket;

FIG. 9 is a flowchart of the different steps of the method for assembling a vehicle door handle assembly according to an embodiment of the present invention;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

In the following of the description, the terms up, upper, low, lower, vertical, horizontal, top, bottom, refer to relative positions or directions when the door handle is assembled to a vehicle.

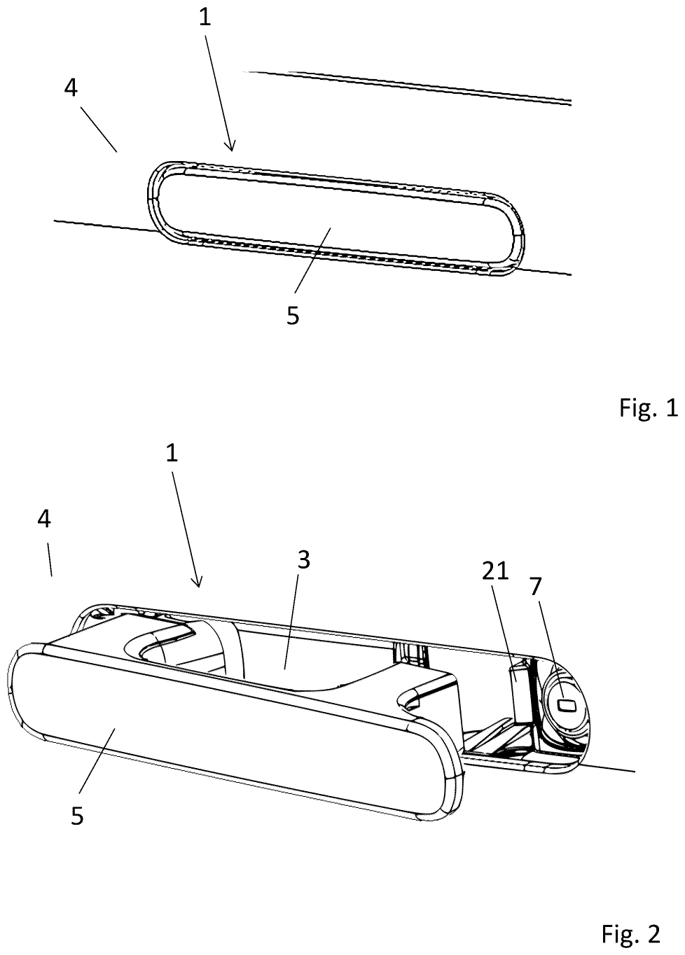

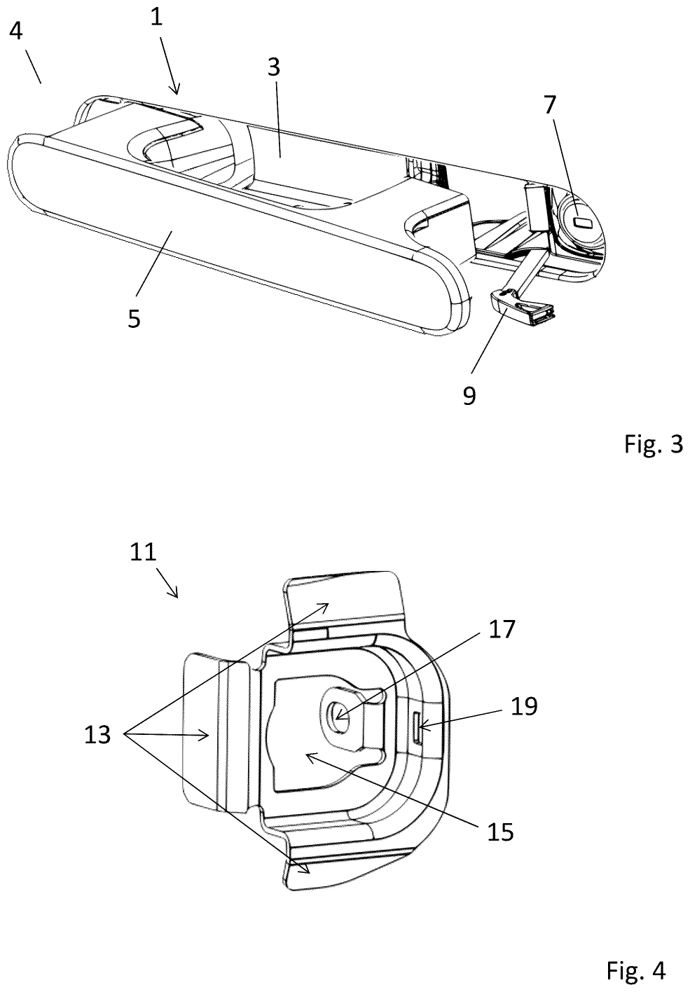

The present invention refers to a vehicle door handle assembly 1 comprising a bracket 3 configured to be fixed to a door panel 4 and a movable handle 5 configured to be fastened to the bracket 3. The bracket 3 is configured to be fixed on an inner side of a door panel, for example by screws. The movable handle 5 is a retractable handle configured for moving between a retracted position represented in FIG. 1 wherein the handle 5 flushes with the external side of the door panel 4 and a deployed position wherein the handle 5 can be grasped and pulled by a user towards an opened position as represented in FIG. 2. In this opened position, the user may access a lock 7 and may introduce a key 9 in the slot of the lock 7 to unlock the door manually as represented in FIG. 3, for example in case of a power shortage.

The vehicle door handle assembly 1 also comprises a security plate 11, also called Thatcham plate, configured for preventing the access to the lock 7 from the outer side of the door panel 4 with a sharp element such as a screwdriver or other tools used by burglars. The security plate 11 is made of a metal material such as steel and is fastened to the bracket 3 next to a recess 6 of the bracket 3 configured for receiving the lock 7. The security plate 11 extends around the lock to prevent a thief from reaching the side parts of the lock with a tool such as a screwdriver.

FIG. 4 represents an example of a security plate 11 having a squared general shape with three fins 13 arranged on three sides of the square and a central opening 15 to enable the insertion of the lock 7. The security plate 11 also comprises a tongue 17 configured to receive a fixing screw or a fork. The security plate 11 also comprises an opening 19 configured to receive clipping means.

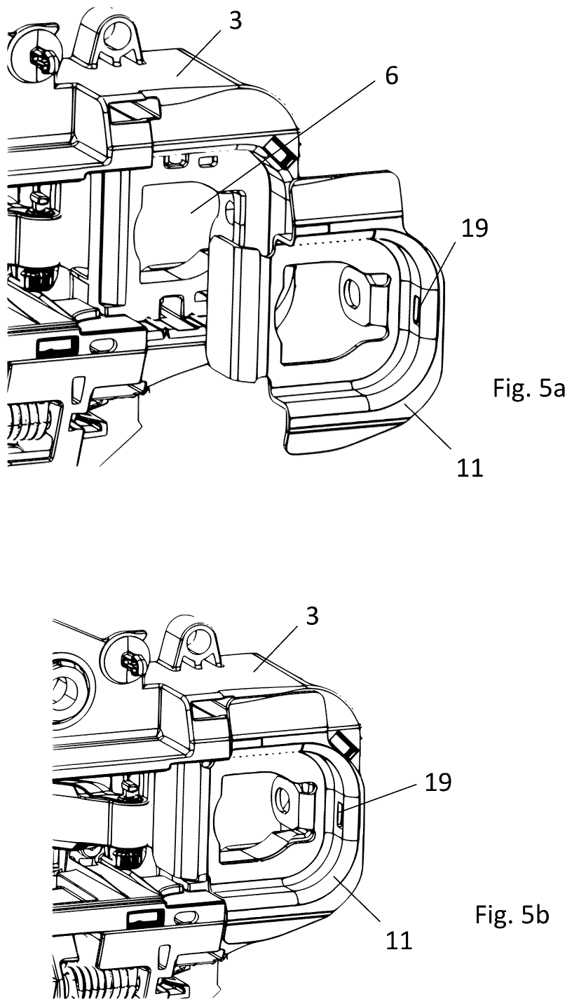

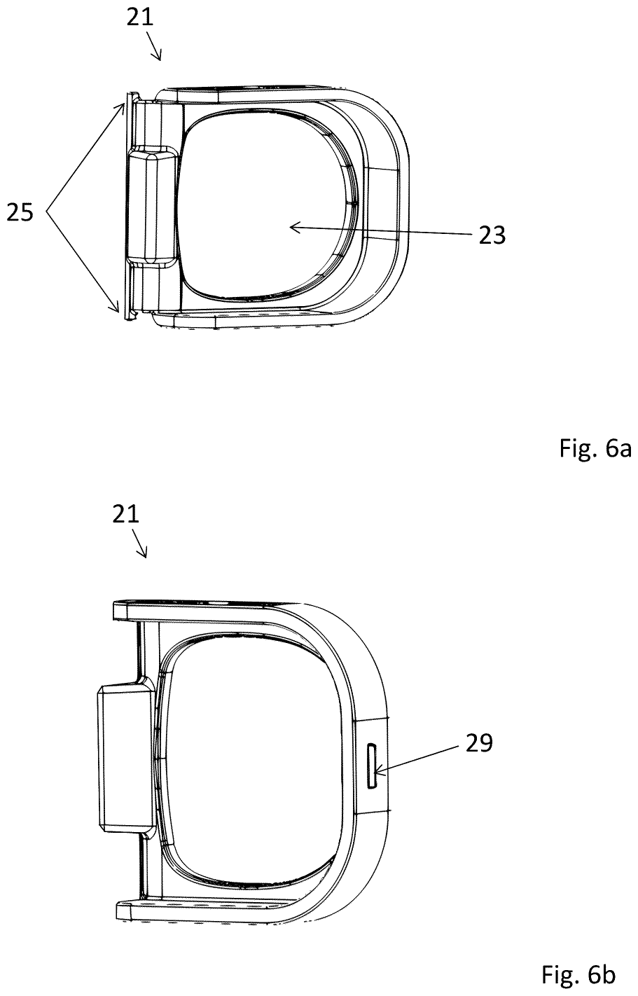

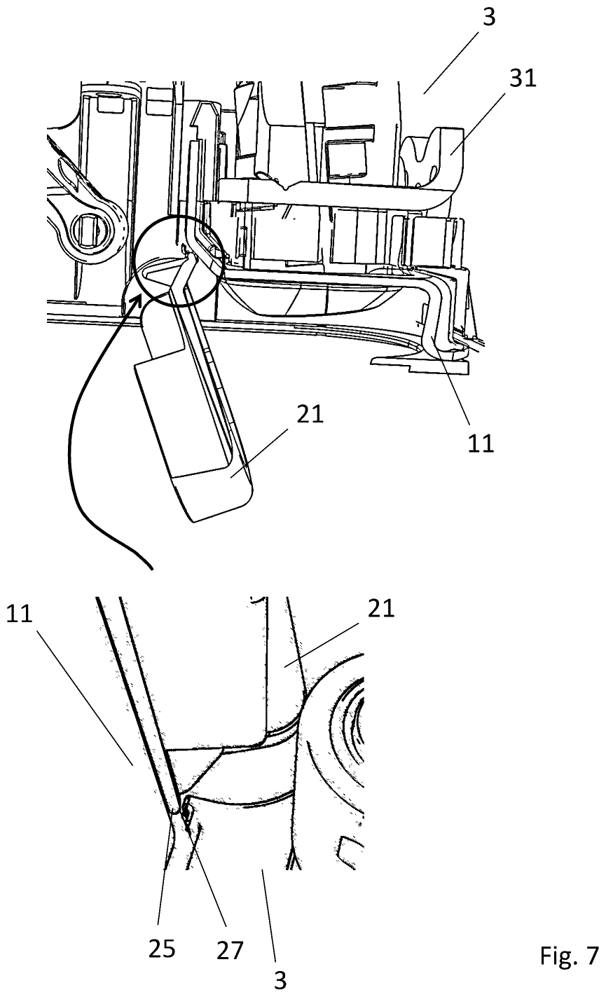

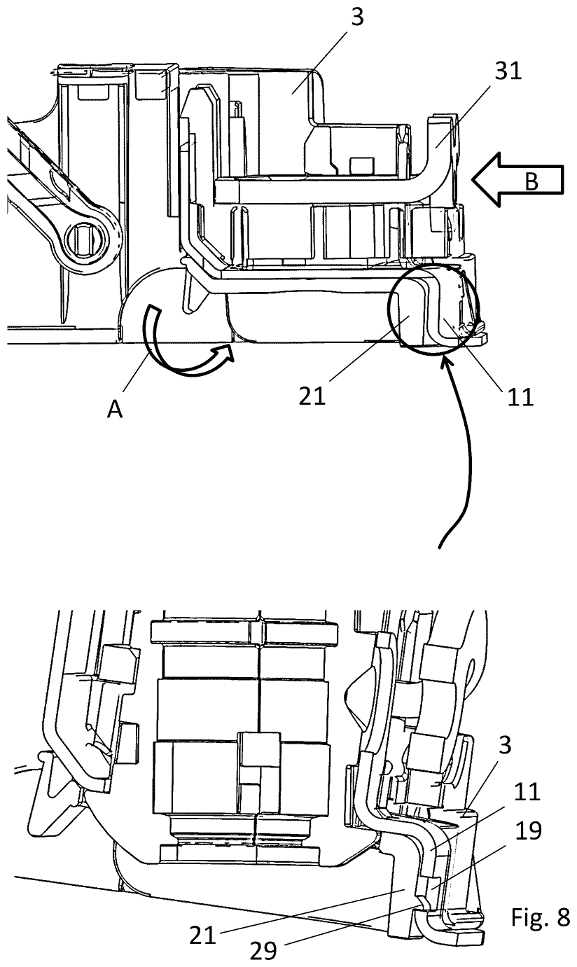

The security plate 11 is configured to be fastened to the bracket 3 as represented in FIG. 5a and FIG. 5b. The security plate 11 may be clipped to the bracket 3 or may just be inserted in a first step. The fastening of the security plate 11 to the bracket 3 may be achieved thereafter with a fork.

The vehicle door handle assembly 1 also comprises a plastic cover 21 configured to be placed above the security plate 11 to cover the security plate 11 and to enable hiding the security plate 11. The plastic cover 21 has a general squared shape at least partially complementary with the shape of the security plate 11. The plastic cover 21 also comprises a central opening 23 to enable the insertion of the lock 7. The plastic cover 21 may be clipped to the security plate and/or to the bracket 3. In the present case, the plastic cover 21 comprises a first and a second pins 25 arranged parallel to each other and in front of each other. The first and second pins 25 are configured to be inserted in slots 27 of the bracket 3 as represented in FIG. 7. Alternatively, the slots can be arranged in the security plate 11. The plastic cover 21 also comprises clipping means such as a hook 29 arranged on the side of the plastic cover 21 opposite to the first and second pins 27 and configured to be positioned within the opening 19 of the security plate 11 as represented in FIG. 8. Alternatively, the opening may be arranged in the bracket 3. Thus, the plastic cover 21 may be fastened to the bracket or to the security plate 11 or to both by introducing the first and second pins 25 within the slots 27 and by rotating the plastic cover 21 to insert the hook 29 within the opening 19 as represented by the arrow A in FIG. 8.

The vehicle door handle assembly 1 also comprises a lock or key-cylinder 7 configured to be introduced within a recess of the bracket 3 which is accessible via the central openings 15 and 23 of respectively the security plate 11 and the plastic cover 21. The lock may be restrained in position in the recess of the bracket by a fork 31 (visible in FIGS. 7 and 8) configured to be displaced in a direction perpendicular to the axis of the recess as represented by the arrow B in FIG. 8. The fork 31 may be displaced by a screw protruding through a hole in the tongue 17 in order to block the axial displacement of the security plate 11.

The lock 7 may be positioned within the recess of the bracket 3 after the fixing of the bracket 3 to the vehicle door panel 4. To do that, the movable handle 5 may comprise a manual release position wherein the movable handle 5 may be rotated enough to enable the lock 7 to be introduced and positioned in the recess 6 of the bracket 3 from the outside of the vehicle door panel 4 (when the bracket 3 is fixed to the inner side of the vehicle door panel 4).

The assembly of the security plate 11 and the plastic cover 21 to the bracket 3 may be achieved before the fixing of the bracket 3 to the vehicle door panel 4. The movable handle 5 may also be fastened to the bracket 3 before the fixing of the bracket 3 to the vehicle door panel 4.

The present invention also refers to a method for assembling a vehicle door handle assembly 1 as described previously on a door panel comprising an opening.

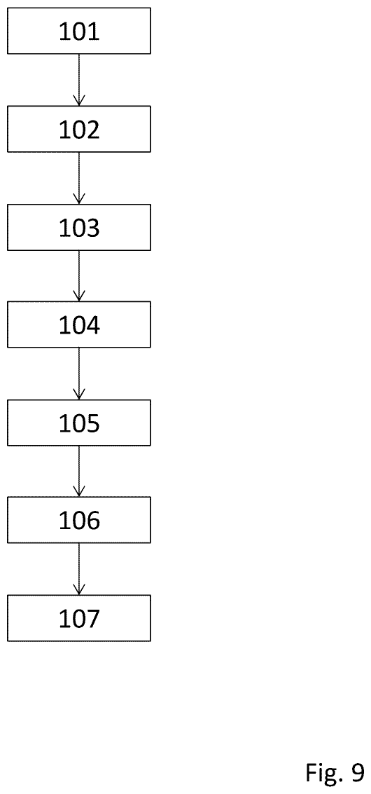

FIG. 9 represents a flowchart of the different steps of the method.

The first step 101 refers to the positioning of the security plate 11 on the bracket 3 as represented in FIGS. 5a and 5b. The security plate 11 is positioned so that its central opening 15 is in front of a recess 6 configured to receive the lock 7. The security plate 11 may be fastened to the bracket 3, for example by clipping or by force insertion or any other suitable fastening means.

The second step 102 refers to the fastening of the plastic cover 21 to the bracket 3 and/or to the security plate 11. In the present case, the plastic cover 21 is fastened on one side to the bracket 3 and on the other side to the security plate 11. Indeed, the plastic cover 21 is first positioned in the bracket 3, in particular its first and second pins 25 are inserted in the slots 27 of the bracket 3 as represented in FIG. 7. The plastic cover 21 is then rotated so that its hook 29 is inserted within the opening 19 of the security plate 11 as represented in FIG. 8.

The third step 103 refers to the positioning of the bracket 3 on an inner side of the door panel 4, the movable handle 5 protruding through the opening of the door panel 4.

The fourth step 104 refers to the fixing of the bracket 3 on the inner side of the door panel 4. The fixing is for example made with screws.

The fifth step 105 refers to the setting of the movable handle 5 in a manual release position or opened position. Indeed, the movable handle 5 needs to be in an opened position to enable the introduction of the lock 7.

The sixth step 106 refers to the introduction of the lock 7 within a recess 6 of the bracket 3 through the central opening 15 of the security plate 11 and through the central opening 23 of the plastic cover 21.

The seventh step 107 refers to the sliding of a fork 31 with a lateral screw to restrain the lock 7 in position in the bracket 3. The lateral screw is also configured to pass through the hole arranged in the tongue 17 of the security plate 11 in order to restrain the security plate 11 in position on the bracket 3.

The different steps of the method may be achieved in a different order. Some steps may be achieved simultaneously and some steps may be optional. For example, the lock 7 may be fastened to the bracket 3 before the fixing of the bracket 3 on the inner side of the door panel 4.

Thus, thanks to the use of a plastic cover 21, the security plate 11 is hidden which enables on one side to prevent a burglar from knowing the exact position of the security plate 11 and on the other side to provide a smooth aesthetic aspect of the vehicle door handle assembly 1 during use. Indeed, the plastic cover 21 may be painted in the same color as the cover of the movable handle 5 and possibly the same color as the door panel 4 in order to provide a homogeneous aspect even when the movable handle 5 is in the deployed position while allowing a user to access the lock 7 to introduce a key 9 to enter his/her car in case of a power outage for example.

1-8. (canceled)

9. A vehicle door handle assembly, comprising:
a bracket configured to be fixed on an inner side of a door panel;
a movable handle fastened to the bracket and configured to move between a retracted position wherein the movable handle flushes with an outer side of the door panel and a deployed position;
a security plate comprising a central opening and configured to be fixed to the bracket;
a lock configured to be positioned within the central opening of the security plate; and
a plastic cover fastened to the bracket and/or to the security plate and configured to cover the security plate, the plastic cover comprising a central opening configured to receive the lock.

10. The vehicle door handle assembly in accordance with claim 9, wherein the plastic cover is clipped to the bracket and/or to the security plate.

11. The vehicle door handle assembly in accordance with claim 10, wherein the plastic cover comprises a first and a second pins arranged on a first side of the plastic cover and configured to be positioned in a respective first and second slots of the bracket or the security plate and a hook arranged on a second side of the plastic cover, opposite to the first side, and configured to be introduced within an opening of the bracket or the security plate for clipping the plastic cover to the bracket and/or to the security plate.

12. The vehicle door handle assembly in accordance with claim 9, further comprising a fork configured to be slid laterally by a screw to restrain the lock and/or the security plate in position in the bracket.

13. The vehicle door handle assembly in accordance with claim 9, wherein the security plate is made of steel.

14. The vehicle door handle assembly in accordance with claim 9, wherein the movable handle comprises a manual release position wherein the lock can be positioned from the outside of the vehicle door panel in a recess of the bracket.

15. A method for assembling the vehicle door handle assembly in accordance with claim 9 on the door panel, the door panel comprising an opening, the method comprising:
positioning the security plate on the bracket;
fastening the plastic cover to the bracket and/or to the security plate;
positioning the bracket on an inner side of the door panel, the movable handle protruding through the opening of the door panel;
fixing the bracket on the inner side of the door panel;
setting the movable handle in the manual release position;
introducing the lock within a recess of the bracket through the central opening of the security plate and through the central opening of the plastic cover; and
sliding a fork with a lateral screw to restrain the lock in position in the bracket.

16. The method in accordance with claim 15, wherein the plastic cover is clipped to the bracket and/or to the security plate.

17. The method in accordance with claim 15, wherein the bracket is fixed on the inner side of the door panel with screws.
